(19) United States
(12) Patent Application Publication
(10) Pub. No.: US 2018/0296956 A1
(43) Pub. Date: Oct. 18, 2018

(54) METHOD AND APPARATUS FOR THE CENTRIFUGAL SEPARATION OF PARTICULATES IN PARTICULATE LADEN FLOWS

(71) Applicant: John Zink Company, LLC, Tulsa, OK (US)

(72) Inventors: Michael Henneke, Tulsa, OK (US); Mark Vaccari, Tulsa, OK (US); Hadj Ali Gueniche, Dudelange (LU); Gilles Theis, Dudelange (LU)

(73) Assignee: John Zink Company, LLC, Tulsa, OK (US)

(21) Appl. No.: 15/953,649

(22) Filed: Apr. 16, 2018

Related U.S. Application Data
(60) Provisional application No. 62/486,558, filed on Apr. 18, 2017.

(51) Int. Cl. B01D 45/16; F23D 14/04; F23D 14/68

(52) U.S. Cl. CPC B01D 45/16; F23D 14/68; F23D 14/04

(57) ABSTRACT

The present invention relates to a system and method of separating particulates from an airflow. The apparatus comprises an air inlet for directing an airflow to a fluid conduit. The fluid conduit has an outer wall curvature with a radius decreasing with azimuthal distance around the fluid conduit. The fluid conduit also has one or more openings in the outer wall through which the particulates pass when the airflow accelerates through the fluid conduit. Particulates accumulate in a particulate collector that is fixed to the fluid conduit and around the one or more openings.

### CROSS REFERENCE TO RELATED APPLICATIONS

This present application claims priority to U.S. Provisional Patent Application No. 62/486,558 filed Apr. 18, 2017 the disclosures of which are incorporated by reference herein.

### TECHNICAL FIELD

The present invention relates to a novel system and method for separating airborne particulates as well as for a burner system utilizing a particulate separator.

### BACKGROUND OF THE INVENTION

Airborne particulates, if not filtered properly, are known to adversely impact operation of a variety of mechanical systems. For example, systems having moving parts or small openings, and especially those operating in highly polluted areas or areas where particulates are in the airstream, may become clogged or damaged. This is especially prevalent in arid areas, such as in desert conditions, where particulates include, but are not limited to sand. In addition to build-up, particulates can also cause erosion in certain mechanical devices.

One such system adversely impacted by airborne particulates is a burner system where particulates in an airflow can build up in the furnace. Excessive build up can clog critical airflow passageways and may result in premature repair or failure of the parts if the particulates are allowed to pass through the burner to the tip of the burner.

Sufficient filtration or other measures are necessary to ensure proper system operation at all conditions. However, depending on the scale and nature of the filtration required, current measures can be costly.

### BRIEF SUMMARY OF THE INVENTION

Embodiments of the present invention provide a novel system and method for removing airborne particulates from an airstream, thus improving the operation of equipment through which the airstream passes, such as a burner or other fluid flow system.

In an embodiment of the present invention, an apparatus for separating airborne particulates is disclosed. The apparatus comprises an air inlet and a fluid conduit in communication with the air inlet, where the fluid conduit has an outer wall curvature with a radius decreasing with azimuthal distance around the fluid conduit. The fluid conduit also has one or more openings in the outer wall. A plurality of vanes are positioned proximate an outlet of the fluid conduit and a particulate collector is fixed to the fluid conduit around the one or more openings, where the particulate collector accumulates particulate through the one or more openings as the particulates separate from an airflow passing through the fluid conduit.

In an alternate embodiment of the present invention, a method of removing airborne particulates is disclosed, where the method comprises directing airflow through an inlet of a separator, the separator having a fluid conduit with an outer wall radius decreasing with azimuthal distance around the fluid conduit and one or more openings in the outer wall of the conduit. The airflow then passes through the fluid conduit such that centrifugal forces cause the airborne particulates to separate from the airflow. The centrifugal forces cause the airborne particulates to pass through the one or more openings in the outer wall of the fluid conduit. Particulates are then collected in a particulate collector secured to the outer wall of the fluid conduit.

In yet another embodiment of the present invention, a burner system is provided comprising an air inlet and a particulate separator having a fluid conduit in communication with the air inlet, where the fluid conduit has an outer wall curvature with a radius decreasing with azimuthal distance around the fluid conduit and one or more openings in the outer wall. A particulate collector is in fluid communication with the fluid conduit at the one or more openings and accumulates particulates as the particulates separate from an airflow passing through the fluid conduit. A burner is in fluid communication with the particulate separator, the burner having a burner inlet, a burner outlet, and one or more fuel sources providing a fuel supply to the burner. The burner receives the airflow from the particulate separator and mixes the airflow with a fuel supply, and ignites the fuel-air mixture.

These and other features of the present invention can be best understood from the following description and claims.

### BRIEF DESCRIPTION OF THE SEVERAL VIEWS OF THE DRAWINGS

The present invention is described in detail below with reference to the attached drawing figures. It is understood that the dimensions such as the thickness, length or width of each section in any part of the illustrated apparatus may be exaggerated in each figure for the sole purpose of illustration. They should not be considered the actual or relative thickness, length or width of any section of the apparatus of the present invention in each figure.

FIG. 1 depicts a perspective view of an embodiment of the present invention.

FIG. 2 depicts a side cross section view of the embodiment of the present invention in FIG. 1.

FIG. 3 depicts a cross section end view of the embodiment of the present invention of FIG. 2.

FIG. 4 depicts a perspective view of a portion of the air inlet region of an embodiment of the present invention.

FIG. 5 depicts a perspective view of an embodiment of the present invention.

FIG. 6 depicts a side elevation view of an embodiment of the present invention.

### DETAILED DESCRIPTION OF THE INVENTION

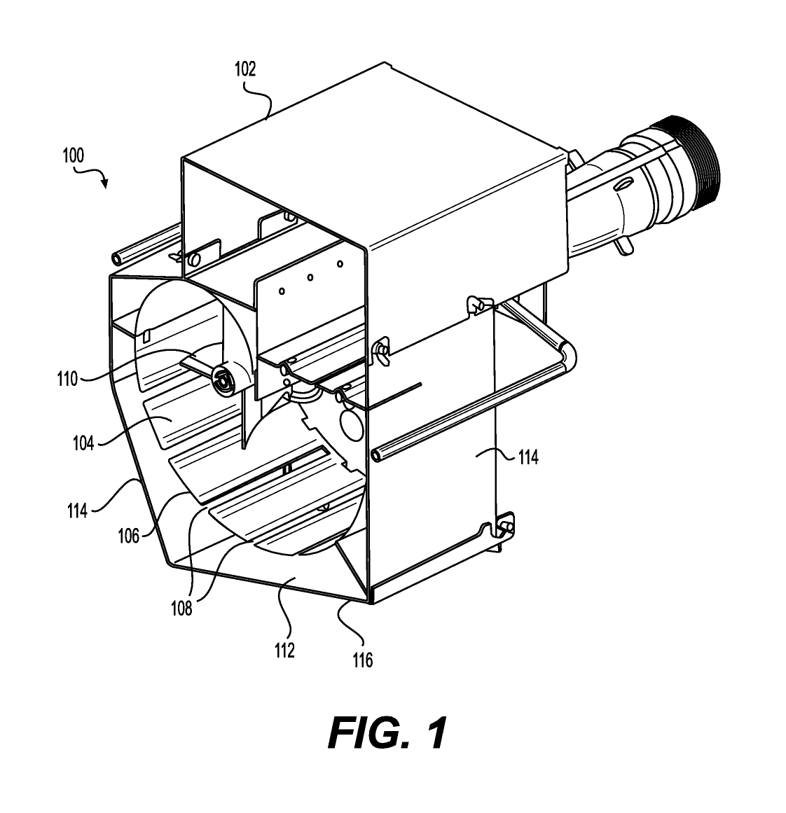

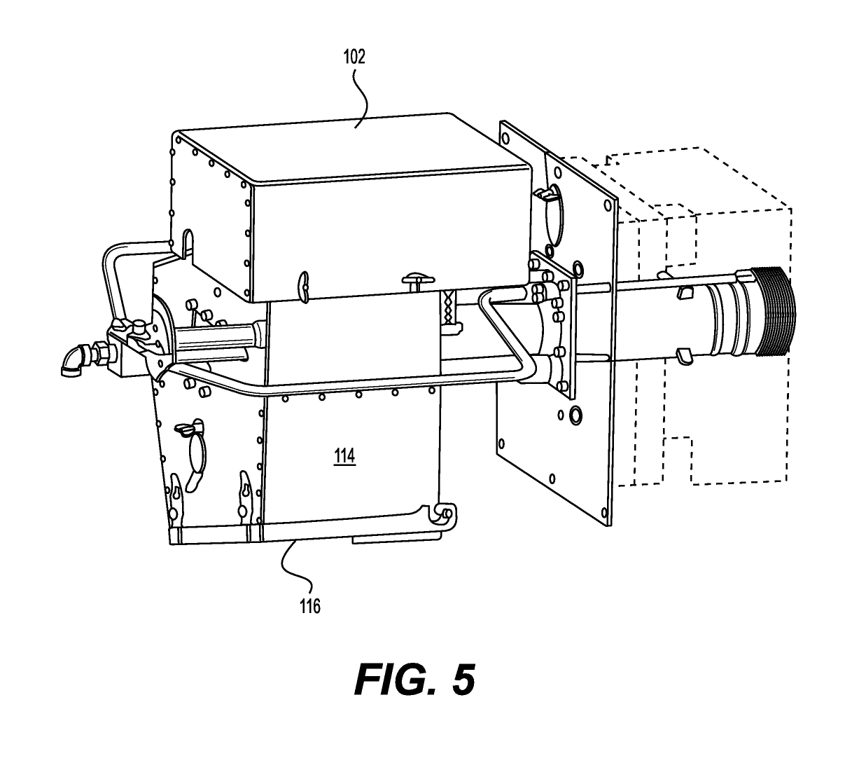

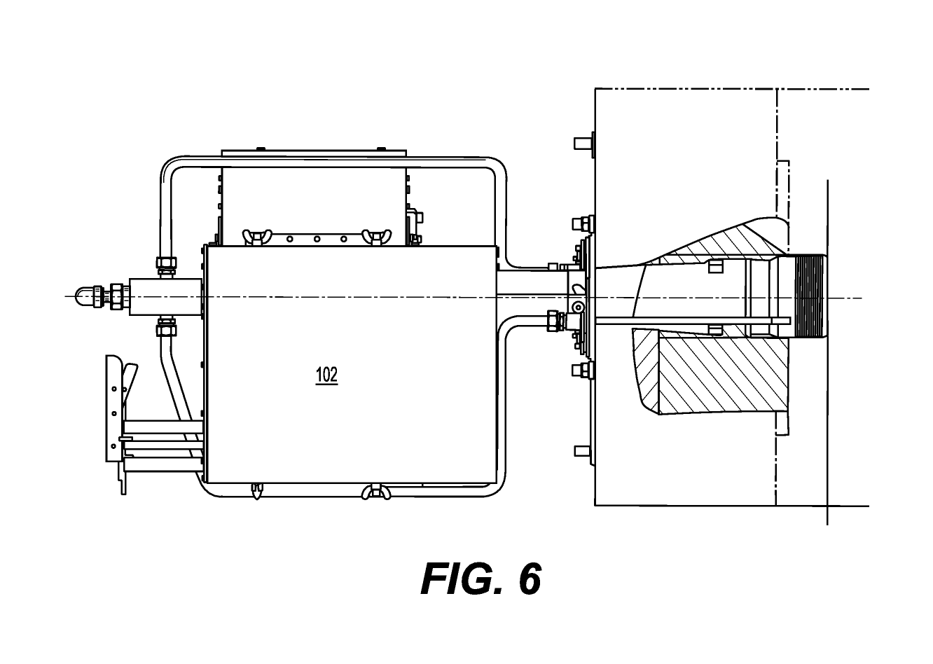

The present invention, as disclosed in FIGS. 1-6, is intended to aid in separating particulates from an airstream. The present invention provides a system and method for helping to remove particulates from an airstream where the particulates are separated and collected for disposal, thus improving the overall air quality.

Referring initially to FIGS. 1-3, a particulate separator 100 is provided. The particulate separator 100 comprises an air inlet 102 and a fluid conduit 104 that is in fluid communication with the air inlet 102. The fluid conduit 104 has an outer wall 106 having a curvature with a radius R decreasing in azimuthal distance around the fluid conduit 104 The fluid conduit 104 also has one or more openings 108 in the outer wall 106. In certain embodiments, the radius of fluid conduit 104 varies smoothly from approximately 12.2 inches to 5.1 inches over an azimuthal distance of 270°. The depth of separator is approximately 11 inches. The openings 108 are approximately 0.59 inches wide and are spaced every 22.5° over 112.5° of the outer wall 106.

In an embodiment of the present invention, a plurality of vanes 110 are positioned proximate an outlet area of the fluid conduit 104. As one skilled in the art will appreciate, the vanes 110, also referred to as deswirl vanes, help straighten an airflow passing therethrough by removing the large tangential velocity component of the airflow created by the fluid conduit 104. Removing this tangential velocity helps recover static pressure, which is critical in fluid flow devices. Reducing the tangential velocity also decreases the amount of pressure drop the airflow experiences as a result of the swirl and further downstream operations with the airflow.

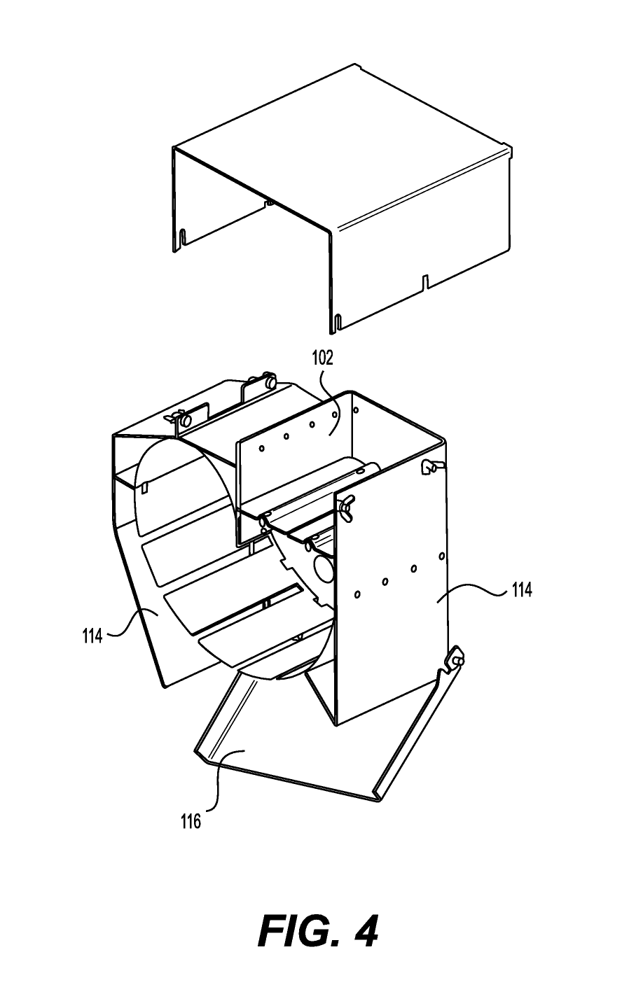

In embodiments, the particulate separator 100 also comprises a particulate collector 112 secured to the fluid conduit 104. The particulate collector 112 can take on a variety of configurations, but is sized and positioned to be fixed to the fluid conduit 104 and around the one or more openings 108. However, the particulate collector 112 must also be able to provide a way of removing the collected particulates. This can be accomplished in a variety of ways, such as having a cleanout in one of the walls 114, removing the particulate collector 112 from the fluid conduit 104, or opening a wall to empty trapped particulate, such as through a moveable wall 116, as depicted in FIG. 4.

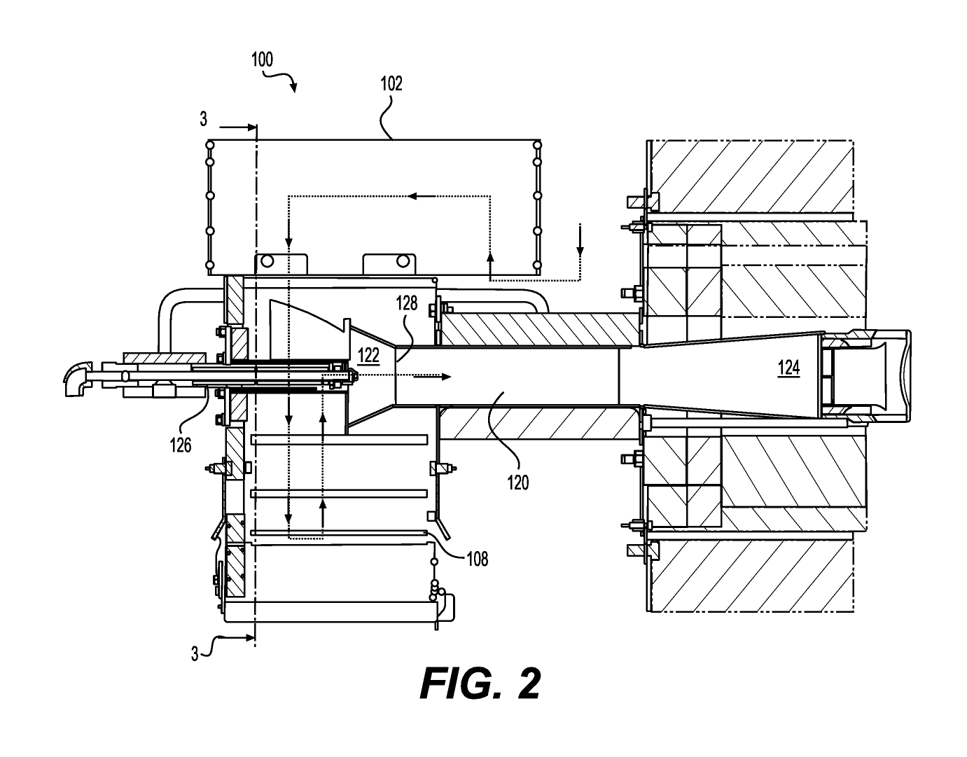

Once the particulates have been removed from the airflow, the airflow can be directed to a subsequent process or location, such as to a burner system 120 or other apparatus for which having cleaner air is advantageous. For the burner system 120, fuel and air mix together and are ignited to produce hot combustion gases. When applying the particulate separator to a burner system, the decreasing radius with azimuthal distance helps to direct a proportional amount of air into a throat region 128 of the burner system 120 (also referred to as a venturi, or minimum cross sectional area of the burner system), as shown in FIG. 2. This minimum area also prevents the airflow from backing up in the burner system 120.

Referring again to FIG. 2, the burner system 120 has a burner inlet 122 and an opposing burner outlet 124 and one or more fuel sources 126, such as a fuel injector, for providing a fuel supply to the burner. The fuel can be injected at a variety of locations depending on the preferred NOx emissions strategy employed. Fuel can be injected at or near the venturi, or throat region 128, via a primary gas jet or through a staged fuel injection where the fuel would be injected at multiple axial locations in the burner.

This fuel-air mixture is then burned by igniting the combustible mixture. One such burner system in which the present invention would be advantageous is a premixed burner, such as a radiant wall premixed burner. In a premixed burner, a venturi is used to accelerate the airflow through a burner where fuel and air are mixed together prior to ignition. As one skilled in the art will understand, the venturi provides a way of accelerating the fuel and airflow through the burner by creating an area of reduced cross section, causing the flow to accelerate.

It is important to understand that the particulate separator geometry is not limited by specific air pressure, temperature, or velocity of the air flow. Furthermore, the specific size of the particulate separator and internal geometry of the present invention may vary depending on the operating environment and airflow conditions.

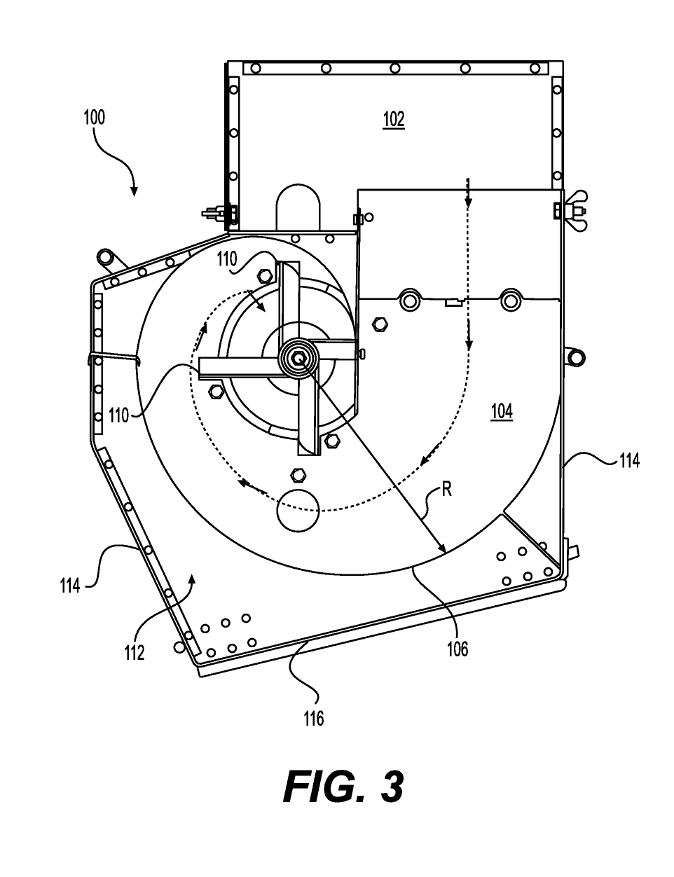

The particulate separator 100 of the present invention, which is utilized to separate particulates from a passing airflow, receives this airflow (indicated by the arrows in FIGS. 2 and 3) at the air inlet 102. The airflow entering the air inlet 102 may be supplied from a variety of devices such as a fan or blower, preferably providing the airflow at ambient conditions.

In another embodiment of the present invention, a method of removing airborne particulates is provided. In operation, the airflow is directed through an inlet of the particulate separator, where the particulate separator has the geometry discussed above—a fluid conduit with an outer wall having a radius that is decreasing with azimuthal distance around the fluid conduit and one or more openings for particulates to pass through. Airflow is passed through the fluid conduit and accelerates, such that the centrifugal forces separate airborne particulates from the airflow and the particulates are directed through the one or more openings in the outer wall.

The airflow passes through the fluid conduit, and given the fluid conduit's decreasing geometry (radius with azimuthal distance), the airflow accelerates and changes direction such that the centrifugal forces cause the airborne particulates to separate from the airflow. The airborne particulates are directed through the one or more openings in the outer wall of the fluid conduit and accumulate in the particulate collector due to the lack of velocity in the particulate collector. The particulates can then be disposed of at a later time.

The airflow, having significantly reduced levels of particulates can then be directed to a subsequent process, such as the burner system depicted in FIGS. 2, 5, and 6. For use in a burner system, it is desired that the airflow has any significant tangential velocity removed since the airflow will undergo a large pressure drop in the burner system.

Although a preferred embodiment of this invention has been disclosed, one of ordinary skill in this art would recognize that certain modifications would come within the scope of this invention. The present invention is not to be limited to the shapes and sizes as disclosed above. Instead, one of ordinary skill in the art will appreciate that the specific sizes and shapes of the components discussed may vary. For that reason, the following claims should be studied to determine the true scope and content of this invention. Since many possible embodiments may be made of the invention without departing from the scope thereof, it is to be understood that all matter herein set forth or shown in the accompanying drawings is to be interpreted as illustrative and not in a limiting sense.

From the foregoing, it will be seen that this invention is one well adapted to attain all the ends and objects hereinabove set forth together with other advantages which are inherent to the structure.

It will be understood that certain features and subcombinations are of utility and may be employed without reference to other features and subcombinations. This is contemplated by and is within the scope of the claims.

Having thus described the invention, what is claimed is:

1. An apparatus for separating airborne particulates comprising:
an air inlet;
a fluid conduit in communication with the air inlet, the fluid conduit having an outer wall curvature with a radius decreasing with azimuthal distance around the fluid conduit and one or more openings in the outer wall;
a plurality of vanes proximate an outlet of the fluid conduit; and,
a particulate collector fixed to the fluid conduit around the one or more openings;
wherein the particulate collector accumulates particulate through the one or more openings as the particulates separate from an airflow passing through the fluid conduit.

2. The apparatus of claim 1 further comprising a fan or blower providing the airflow to the air inlet.

3. The apparatus of claim 1, wherein the airflow is directed to a burner system.

4. The apparatus of claim 3, wherein the burner system is a premixed burner.

5. The apparatus of claim 1, wherein the particulate collector has a mechanism for removing the airborne particulates.

6. The apparatus of claim 5, wherein the mechanism is a moveable wall.

7. A method of removing airborne particulates comprising:
directing airflow through an inlet of a separator, the separator having a fluid conduit with an outer wall radius decreasing with azimuthal distance around the fluid conduit and one or more openings in the outer wall of the conduit;
passing the airflow through the fluid conduit such that centrifugal forces separate the airborne particulate from the airflow;
wherein the centrifugal forces direct the airborne particulates through the one or more openings in the outer wall of the fluid conduit; and,
accumulating the particulate in a particulate collector secured to the outer wall of the fluid conduit.

8. The method of claim 7 further comprising removing tangential velocity from the airflow by directing the airflow through a plurality of vanes.

9. The method of claim 8 further comprising directing the airflow through a venturi for mixing the airflow with a fuel.

10. The method of claim 9 further comprising directing the airflow to a burner.

11. The method of claim 10, wherein the burner is a radiant wall premixed burner.

12. The method of claim 7 further comprising removing the airborne particulates from the particulate collector.

13. A burner system comprising:
an air inlet;
a particulate separator comprising:
a fluid conduit in communication with the air inlet, the fluid conduit having an outer wall curvature with a radius decreasing with azimuthal distance around the fluid conduit and one or more openings in the outer wall; and,
a particulate collector in fluid communication with the fluid conduit at the one or more openings;
wherein the particulate collector accumulates particulate through the one or more openings as the particulates separate from an airflow passing through the fluid conduit; and,
a burner in fluid communication with the particulate separator, the burner having a burner inlet, a burner outlet, and one or more fuel sources providing a fuel supply to the burner;
wherein the burner receives the fuel supply and the airflow from the particulate separator, and ignites the airflow and the fuel supply.

14. The burner system of claim 13 further comprising a fan or blower providing the airflow to the air inlet.

15. The burner system of claim 13, wherein the burner comprises a venturi having a throat with a reduced cross sectional area.

16. The burner system of claim 13 further comprising an ignition system.

17. The burner system of claim 13, wherein the burner is a premixed burner.

18. The burner system of claim 13 further comprising a plurality of vanes proximate an outlet of the fluid conduit.

19. The burner system of claim 13, wherein the particulate collector has a mechanism for removing the airborne particulates.

20. The burner system of claim 19, wherein the mechanism is a moveable wall.
